(19) United States
(12) Patent Application Publication
(10) Pub. No.: US 2026/0229883 A1
(43) Pub. Date: Aug. 6, 2026

(54) ELECTROSTATIC DISCHARGE PROTECTION CIRCUIT FOR A DEVICE UTILIZING POWER LINE COMMUNICATION

(71) Applicant: AGI SureTrack LLC, Lenexa, KS (US)

(72) Inventors: Nathaniel HUNT, Grandview, MO (US); Peter LAVIN, Overland Park, KS (US); Tianyu LIN, Raymore, MO (US); Gordon SMITH, Delta, CA (US)

(21) Appl. No.: 19/045,205

(22) Filed: Feb. 4, 2025

(51) Int. Cl. H02H 9/04; H02H 3/20; H02H 7/20

(52) U.S. Cl. CPC H02H 9/042; H02H 3/202; H02H 7/20

(57) ABSTRACT

A powered circuit, such as a sensor circuit that is configured to be affixed to a power distribution cable in a grain bin temperature and humidity sensing system, is subject to electrostatic discharge (ESD) events. The circuit described herein provides a discharge path that advantageously diverts charge in an ESD event to the power bus ground while protecting internal components in the powered circuit from ESD damage. A probe circuit has an ESD probe that is located proximate to an aperture in a circuit housing cover. The probe circuit is connected to the input power bus ground. An isolation circuit coupled to the input power bus isolates circuit board power and ground from the power and ground supplied by the power bus. The isolation circuit includes a resistor serving as a component of a low-impedance power loop. A limiting component limits the voltage experienced by the powered circuit.

### BACKGROUND

Electrical charge buildup occurs when electrons are torn away from a host surface, making it positively charged. The transfer surface becomes negatively charged by the buildup process. For example, a plastic rod when rubbed with fur will pick up electrons from the fur, thus the plastic rod will become negatively charged, while the fur becomes positively charged. An electrostatic discharge (ESD) event occurs, for example, when the negatively charged rod comes in contact with an earth ground, causing the rod to lose its charge when the electrons flow to ground. Likewise, a discharge event may occur when the fur is brought to earth ground, so that it picks up electrons from the earth.

Circuits that control ESD are generally advantageous in the modern electronics era for a number of reasons. First, modern electronics often include ESD sensitive transistors that degrade from charge distribution events. It is generally advantageous to divert electronic charge to provide a reliable circuit that performs close to factory levels despite repeated static discharge events. Additionally, under certain conditions ESD can ignite flammable gas or grain dust causing a dangerous explosion. Therefore, an electrical discharge diversion circuit is equipped to improve the reliability of a product by preventing circuit degradation, and also by preventing property damage and harm caused by an explosion that results from uncontrolled ESD.

### SUMMARY

At a high level, the technology described herein relates to effective diversion of electrostatic discharge in a circuit powered by an input power bus. The powered circuit has a probe circuit connected to the input DC power bus ground. The probe circuit includes an electrostatic discharge probe, which is located proximate to an aperture in an enclosure that generally covers a circuit board. The powered circuit also includes an isolation circuit connected to input power and input ground, which isolates the input power and the input ground from the circuit board power and from the circuit board ground. The isolation circuit includes a resistor that serves as a component of a low-impedance power loop and is connected between an input power node and an output power node of the isolation circuit. The powered circuit further includes a limiting circuit connected to the isolation circuit that limits, for the powered circuit, the circuit board voltage relative to the circuit board ground.

In another aspect, a method of providing electrostatic discharge diversion includes providing a circuit board housing with an aperture on a surface of the housing that covers the circuit board. The circuit board is designed to align mechanically within the housing, ensuring the electrostatic discharge probe on the circuit board aligns with the aperture. The probe is part of a probe circuit that is connected to the input ground of the input power bus of the circuit board. An isolation circuit is connected to an input power bus and provides circuit board power and circuit board ground. The isolation circuit includes one or more resistors that serve as a component of a low-impedance power loop. A voltage limiting circuit connected to the isolation circuit limits, for a powered circuit, the circuit board voltage relative to circuit board ground.

In an additional aspect, an article of manufacture for sensing the environmental condition of grain in a grain bin includes an electrostatic discharge mechanism for a powered sensor circuit. The circuit board housing has one or two apertures on the cover and provides sensed data over an input DC power bus. The circuit board housing is designed to be mechanically positioned within the housing so that a probe of the circuit board is approximately aligned with the one or two apertures so as to provide a discharge path through the one or two apertures to the input ground of DC power bus. A probe circuit includes the probe and is connected to the DC power bus ground. An isolation circuit connected to the input power bus isolates DC input power from sensor circuit power and insulates DC power bus ground from sensor circuit ground. The isolation circuit includes a first resistor connected between an input power node and a sensor circuit power node, and a second resistor connected between an input DC ground node and a sensor circuit ground node. The resistors may serve as components in a low-impedance power loop. A voltage limiting circuit connected between sensor circuit power and sensor circuit ground limits the voltage for the sensor circuit.

This summary is intended to introduce a selection of concepts in a simplified form that are further described below in the detailed description section of this disclosure. This summary is not intended to identify key or essential features of the claimed subject matter, nor is it intended to be an aid in determining the scope of the claimed subject matter.

Additional objects, advantages, and novel features of the technology will be set forth in part in the description that follows, and in part, will become apparent to those skilled in the art upon examination of the following or learned by practice of the technology.

### BRIEF DESCRIPTION OF THE DRAWINGS

The present technology is described in detail below with reference to the attached drawing figures, wherein:

FIG. 1 is an example power distribution system, in accordance with an embodiment described herein; and

FIG. 2 is an example assembly of a powered device, in accordance with an aspect described herein.

### DETAILED DESCRIPTION

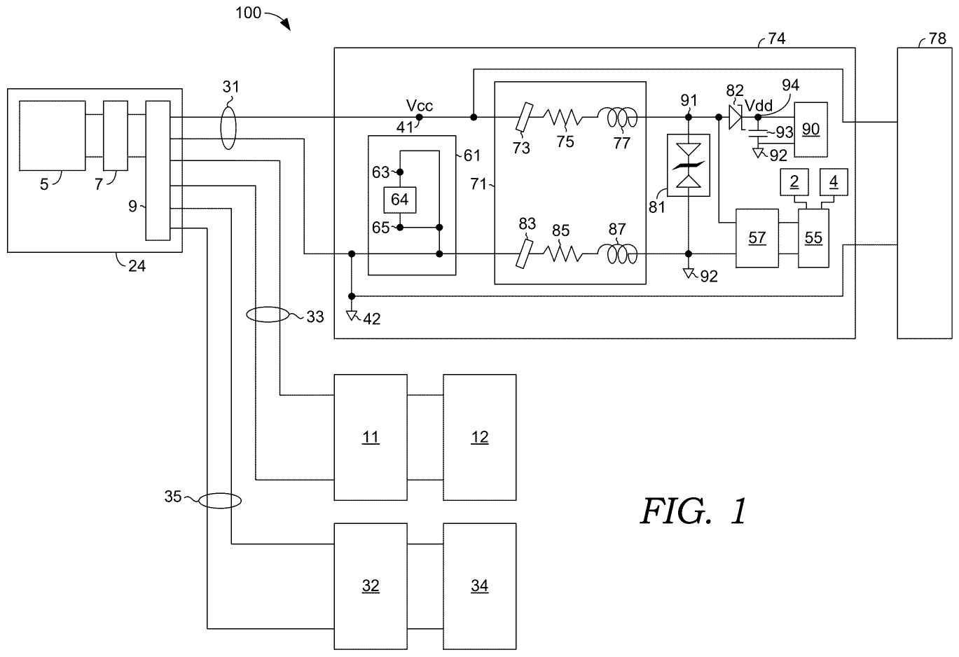

Referring to FIG. 1, a block diagram of a power distribution system is generally indicated by reference numeral 100. A power source 24 is connected via cable 31 to power sinks 74 and 78, forming a chain of power sink units. In an embodiment, a chain of power sink units has only a single power sink 74. In an embodiment, a chain of power sink units comprises a chain of two or more power sink units, similar to power sink 74, which are wired in parallel to a cable, such as cable 31. In another embodiment, a chain of power sink units comprises between three and sixty-four powered sink units. As another example, cable 33 forms a cable chain comprising power sink units 11 and 12, while cable 35 forms a cable chain comprising power sink units 32 and 34. In an embodiment, a cable such as cable 31 includes a steel cable that provides inertia for a sensor chain so that a cable chain remains in a relatively stable position, and so that power and ground lines in cable 31 do not bear the tensile or ductile strain present on cable 31. In an embodiment, cable 31 comprises two steel braided cables which are isolated from one another and serve as cable voltage VCC 41 and cable ground 42, respectively.

In an embodiment, the power distribution system 100 provides three-dimensional monitoring of the conditions of grain in a grain bin by sensing humidity and temperature at each location within a grain bin using power sink units such as 74, 78, 11, 12, 32, and 34 as sensors, and reporting the status to the power source unit 24 over the cables 31, 33 and 35 that are geometrically dispersed within the grain bin to form a three dimensional sampling along a cable that dangles from the roof of a grain bin. Other configurations of sensors such as forming a cable loop with the sensors may also be employed. Power source unit 24 communicates the sensor status reports from the sensors to a user, e.g. by displaying the condition at a display connected to power source unit 24, or by reporting the conditions from power source unit 24 to another wireline connected master unit, which displays conditions in a connected display at a master unit. In an embodiment, data is transmitted over cellular and viewed online or can be viewed through a phone using Bluetooth which is built into the power source unit 24. In an embodiment, data is sent from source unit 24 via a cellular modem to a cloud service where the data can be viewed online. In an embodiment, SMS updates are pushed by the cloud service and not sent directly from a cellular connection to a user. In an embodiment, power source unit 24 communicates directly or indirectly through a wireline connected master unit by using a mobile telephone link that provides SMS status to a user with alerts, or with images that display present conditions. In an embodiment, the SMS channel can also control other equipment on command from a user. In an embodiment, equipment which is local to the grain bin, such as a grain dryer and/or a fan, is turned on or turned off based on the sensed condition of the grain in the grain bin.

In an embodiment, the location of sensor chains and the locations of sensors within a sensor chain are known by system 100, so that a three-dimensional model is constructed from the sensed information. For example, power sink units 74 and 78 are spaced as sensors from a foot apart to 8 ft apart, typically depending upon the features of the grain bin. In an embodiment, cable 31 has a lead run of a hundred and twenty feet, and then a sensor chain of less than 200 ft. In an embodiment, sensor chains are evenly spaced within a bin and the location of each chain is fed into the master node so that a three dimensional location of each sensor is used to form a three dimensional database of the sensed values.

When a grain bin is emptied, the grain typically rushes by a power sink unit 74 and the grain may have an electrostatic charge which then discharges through a power sink unit 74. This electrostatic discharge is handled reliably and safely by the technology disclosed herein. For example, a powered sensor circuit advantageously complies with IEC 60079-11, and provides with a resistor 75 and resistor 85, a design which accommodates more than 1000 sensors. Each sensor, in an embodiment, withstands hundreds of ESD discharges, where a single ESD discharge event includes a positive or negative strike of magnitude which is at least 30 KV.

In an embodiment, cable 31 comprises a power bus that provides input power voltage VCC at node 41 and input ground 42 over cable 31 to power sink 74. In an embodiment, VCC is a direct current (DC) voltage level. In an embodiment, the input voltage VCC is low voltage, less than 50 volts. In an embodiment, input voltage VCC is nominally 5 or less volts. In an embodiment, VCC is extra-low voltage, such as less than 50 volts AC rms or 120 volts DC.

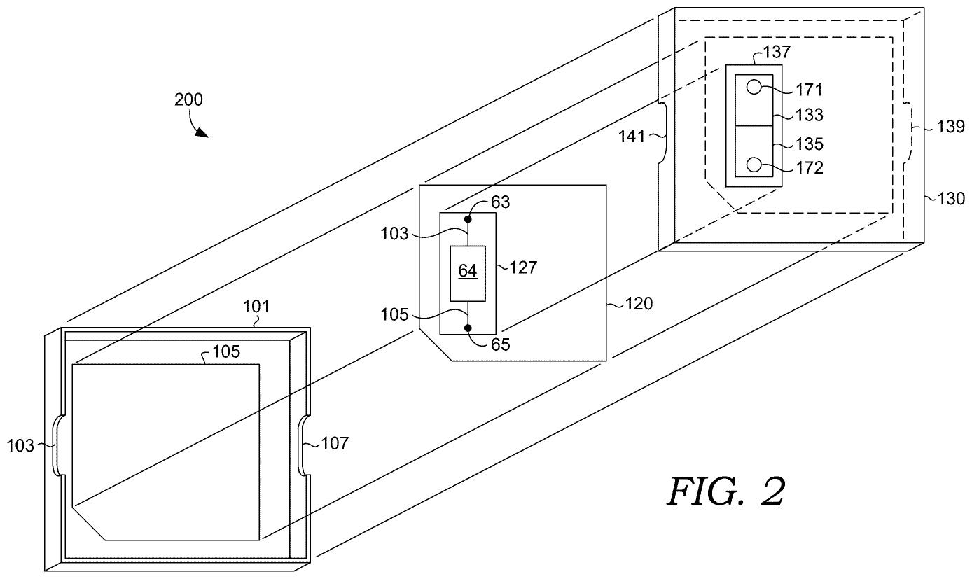

In an embodiment, a power sink 74 comprises electrical components such as a probe circuit 61, an isolation circuit 71, and a voltage limiting circuit 81. In an embodiment, the powered circuit includes all those parts that are powered, and comprises one or more of the parts on circuit board 120, as shown in FIG. 2, which are not contained in the ESD diversion circuit, such as voltage regulator 90, modem 57, processor 55, sensor 2, and control 4. In an embodiment, the powered circuit includes sensor component 2 which communicates sensed values to processor 55. In an embodiment, the powered circuit includes control component 4 which takes control commands from processor 55. Sensor component 2 and control component 4 are powered by circuit board voltage at node 91 and have a ground reference of ground 92.

The probe circuit 61 has a probe 64 located in an area 127 of circuit board 120, which is proximate to a corresponding area 137 of a top cover 130. A probe 64 generally includes an electrode, that is, a conductive node through which electricity enters probe circuit 61. In an embodiment, an electrode comprises at least one of a conductive surface of a resistor, a lead of a resistor, a tinned area on a resistor, a conductive surface of a test point, a conductive surface of a jumper, and a conductive surface of a pin terminal. The top cover includes one or more apertures, such as apertures 171, 172. That is, probe 64 is physically and mechanically located to provide a discharge path to input ground for an area 137 of an assembly 200, as shown in FIG. 2. Assembly 200 comprises a bottom cover 101, a circuit board 120 and a top cover 130. Top cover 130 mechanically engages bottom cover 101 to provide an enclosure or housing for circuit board 120. The housing formed by assembly 200 has an opening formed by inlet portions 103 and 141 for cable 31 as it enters the housing. In an embodiment, cable 31 exits a housing formed by assembly 200 at an opening formed by outlet portions 107 and 139. A cable such as cable 31 has electrical and mechanical connections to circuit board 120. When assembly 200 is assembled, area 127 on circuit board 120 is beneath area 137 on top cover 130. A cover such as top cover 130 has one or more apertures or openings e.g. 171, 172 in area 137 to provide a path for charge to flow to probe 64 and/or to adjacent trace 103 that electrically connects probe 64 to input ground 42 at node 63. An electrically conductive path, such as a trace, lead, or conductive surface is generally referred to as a line. Additionally, or alternatively, charge may flow in a path to probe 64, or to adjacent trace 105 that electrically connects probe 64 to input ground 42 at node 65. In an embodiment, a single aperture over area 137 engages a single probe on the circuit board over area 127. In an embodiment, probe 61 as a single trace to input ground 42. In an embodiment, a probe 64 has a trace from each end of probe 64 to input ground 42.

In an embodiment, probe circuit 61 includes probe 64 that is electrically connected to nodes 63 and 65 with electrical connections to input ground 42. Preferably the traces within probe circuit 61 that provide connection to input ground 42 are short, and well insulated from other parts and from other non-input ground traces on circuit board 120. For example, a minimum spacing of 0.5 mm from cable ground 42 to circuit board ground 92 is achieved everywhere. Similarly, a minimum spacing of 0.5 mm from cable power VCC at 41 and circuit board ground 91 likewise achieved everywhere. Such a minimum spacing prevents production of ignition heat source, which might be caused by a short-circuit fault condition. In an embodiment, probe 64 is a resistor of non-zero resistance, so that a charge transfer to either lead of a resistive element will transfer charge in the direction away from the resistor to the input ground either in the direction of node 63 or in the direction of node 65, respectively. In an embodiment, one or more the leads of a resistor in probe 64 form a mechanically prominent portion of probe 64, e.g. by use of a surface-mount or through-hole resistive element, and/or with a lead of the resistor that for some distance extends away from the surface of circuit board 120 toward an aperture in area 137, before returning to the board to make electrical contact in an electrical surface-mount or through-hole connection. In an embodiment, a portion of probe 64 is partially obscured by case 130, e.g. when a first aperture 171 is placed toward the outer edge of area 133 and a second aperture 172 is placed toward the remote outer edge of area 135, thus forming a top cover portion between the two apertures 171 and 172 that consists of the material of top cover 130. In an embodiment, one or more of the apertures are circular. In an embodiment, top cover 130 and bottom cover 101 are made of insulating material such as molded plastic. In an embodiment, trace 103 and trace 105 are not formed, but instead, a surface-mount or through-hole lead of probe 64 is attached at node 63 and/or a surface-mount or through hole lead of probe 64 is attached at node 65. In an embodiment, probe 64 is a surface mount resistor. In an embodiment, aperture 171 is centered over a lead of probe 64. In an embodiment, aperture 172 is centered over a lead of probe 64. In an embodiment, the shape of an aperture such as 171 is slotted, and is greater than the lead diameter of a lead of probe 64. For example, a slotted aperture 171 is three times the diameter of the lead, so that a lead may protrude through aperture 171. In an embodiment, a lead of probe 64 or the body of the lead protrudes through an aperture of cover a cover such as top cover 130.

In an embodiment, probe 64 is a resistor. In an embodiment, probe 64 is a trace. In an embodiment, probe 64 is a PC test point such as Keystone Electronics® 5029. In an embodiment, probe 64 is a jumper, such as Keystone Electronics® 5112 zero Ohm jumper chip resistor, Vishay Dale® CRCW06030000Z0EA, or any similar component that may be the same or greater in height than resistor 75 and resistor 85. In an embodiment, probe 64 is a pin terminal such as Mill-Max® Manufacturing Corp. 3137-1-00-34-00-00-08-0.

Isolating circuit 71 performs the function of isolating the input voltage VCC at 41 from the circuit board internal voltage at 91, and perhaps also the function of isolating the input ground 42 from the circuit board internal ground 92. In an embodiment, isolating circuit 71 isolates node 41 from node 91 by only a power resistor 75. A resistance value of 75 ohms for resistor 75 limits the energy at power sink unit 74 and thus prevents power sink unit 74 from becoming a heat ignition source. Such a low value for resistor 75 also provides low impedance so that modem 57 is equipped to send current modulated information over cable 31, thus resistor 75 advantageously serves as a component of a low-impedance power loop over cable 31. In an embodiment resistor 85 also provides a low impedance value which has the same nominal value as resistor 75, and thus both resistors serve as components in a low-impedance power loop over cable 31. In an embodiment, a low nominal value for resistor 75 ranges from 25 ohms to 250 ohms. In an embodiment, both resistor 75 and resistor 85 are chosen with high enough resistance to prevent partial semiconductor conductivity. Semiconductors can become partially conductive in a failure mode. High enough resistance prevents a resistor from becoming a thermal ignition source. In an embodiment, resistors 75 and 85 have equal nominal value and are chosen in the range from 25 ohms to 250 ohms. In an embodiment, isolating circuit 71 isolates input ground 42 from the circuit board internal ground 92 only by an isolating power resistor 85. In an embodiment, one or more additional elements are present in a power supply path of isolating circuit 71, such as series connected ferrite bead 73 and/or series connected inductor 77 to isolate node 41 from node 91. In an embodiment, one or more additional elements are present in the ground path of isolating circuit 71, such as series connected ferrite bead 83 and/or series connected inductor 87 to isolate input ground 42 from circuit board internal ground 92.

Voltage limiting circuit 81 protects the internal circuit board voltage at node 91 from over-voltage conditions. For example, when the input voltage is nominally 5 volts, limiting circuit 81 is chosen to have a breakdown voltage at higher threshold such as 7 volts. So that when the voltage at node 91 is above 7 volts, the voltage limiting element 81 clamps the voltage at 7 volts by passing current from node 91 to circuit board internal ground 92. In an embodiment, voltage limiting circuit 81 is a single Zener shunt diode, as shown.

In an embodiment, voltage limiting circuit 81 is one of a transient voltage suppression diode, a Zener diode, a gas discharge tube, a metal oxide varistor, and an RC snubber. In an embodiment, voltage limiting circuit 81 is any combination of the following parallel connected devices: a transient voltage suppression diode, a Zener diode, a gas discharge tube, a metal oxide varistor, and an RC snubber.

In an embodiment, resistor 75, resistor 85 and most other circuit elements on circuit board 120 are coated after assembly by one or more coats of conformal coating, with the exception that the area 127 of the circuit board 120 is not coated, so that the probe 64 and perhaps some surrounding area are not electrically isolated from ESD, but the other components on circuit board 120 generally are electrically isolated from ESD. In an embodiment, probe 64 is a quarter-watt 75-ohm resistor. In an embodiment, resistors 75 and 85 are quarter-watt 75-ohm resistors. A low power limit such as a quarter watt for resistors 75 and 85 provides an advantage of permitting reduced size of components on circuit board 120, and also a reduced size of assembly 200. In an embodiment probe 64 is greater than or equal to the heights of resistor 75 and 85. In an embodiment, the size of resistors 75 and 85 are chosen to dissipate power that is at least equal to two thirds of their nominal power rating. In an embodiment, the power bus operates well below 1 watt, e.g. a maximum of 40 mA at a master source unit. In an embodiment, resistors 75 and 85 are nominally equal. That is, they are chosen at the same intended value, e.g. 75 ohms, and are chosen with the same tolerance such as 1%, 5% or 10%, and with the same power rating.

In an embodiment, the probe 64 is placed at one surface of circuit board 120, and the opposing surface of the circuit board 120 has a first conductive pad for input power connection to cable 31 and a second conductive pad for input ground electrical connection to cable 31.

In an embodiment, power source 24 periodically interrupts the power supplied over cable 31, e.g. under the control of processor 5. For example, the power supply may be interrupted so that processor 5 can communicate with processor 55 using communication component 7, and processor 55 communicates with processor 5 using communication component 57. In an embodiment, communication components 7 and 57 are modems which perform a link layer encoding of bits between a processor and a wireline channel. In an embodiment, the power is suspended for about a millisecond and the communication between processor 5 and processor 55 is bidirectional. In an embodiment, during a suspension of power about 10 bits are sent and/or received on the channel between modem 57 and modem 7. During an outage of supplied power from power source 24, the local circuit voltage 91 is maintained at node 94 to VDD by sustain capacitor 93 and series-connected diode 82, so that local voltage regulator 90 regulates supply of local power to circuit board 120 before and/or after an input power outage.

In an embodiment, the processor 5 controls the system 100 to communicate with each power sink in a communication cycle. For example, multiplexer 9 is controlled by processor 5 to provide power in a power bus over cable 31. Processor 5 then interrupts power to cable 31, and processor 55 on power sink 74 sends a message to processor 5 using modem 57. In a second, subsequent interruption, by processor 5, the power source unit 24 sends from processor 5 a data message to power sink unit 74. In a third power interruption, processor 5 likewise receives a message from the processor on power sink 78. In a fourth power interruption, processor 5 sends a message to a processor similar to processor 55 that is located on power sink 78.

In an embodiment, processor 5 controls multiplexer 9 to apply power to cable 33, when power is suspended from cable 31, and power is not applied again to cable 31 until all other power sink units have had a communications cycle with processor 5. In an embodiment, of a power cycle with processor 5, power source 24 uses voltage modulation while applying power to power sink 74. After processor 5 disrupts power for power sink 74, processor 55 communicates via modem 57 to processor 55 via modem 7. Capacitor 93 sustains voltage at node 94 to VDD for power sink 74 during the planned power interruption caused by processor 5. In an embodiment, communication during a power interruption is unidirectional. In an embodiment, communication during a power interruption is bidirectional. The power sink units in the power sink chain of cable 33 are each likewise given opportunity to communicate during a power interruption in a communications cycle. Subsequently cable 33 has power removed, and cable 35 has power applied and subsequently interrupted similarly, so that each power sink unit in the chain attached of cable 35 has an opportunity for communications during power interruption. Processor 5 then begins the procedure again, by applying power to cable 31.

In an embodiment, power source units 24 are operated in parallel to multiple chains, with each chain having two or more power sink units, and a central controller collects information from all units such as power source 24 through wireline or wireless communication and aggregates the information from downstream power sink units, and also sends aggregated information by wired communication with a master or by wireless communication to a remote computer or phone with a processor for display to a user on a display interface. In an embodiment, the information of such a system is used for automated control of local equipment, e.g. a grain dryer system which turns on one or more dryers or that turns on a selected dryer near a location of low temperature and/or high humidity. Similarly, when temperature is above a certain level, and/or humidity is below a certain level, the automated system turns off a grain dryer and/or a fan. Local equipment may generally include agricultural product regulation that performs processes such as drying, rehydrating, cooling, warming, and the like. A common term used for drying agricultural products in a grain bin is “in-bin natural air drying” (NAD).

In an embodiment, eight different cables are handled by multiplexer 9. In an embodiment, each power sink cable has up to thirty-two sensors. In an embodiment, up to eight parallel power source units, such as power source unit 24, are operated in parallel and information is aggregated through wired data transfer to a master power source unit. In an embodiment, power source units are also alternately powered in a cycle, and information is aggregated from alternately powered power source units by an analogous method. In an embodiment, a power source unit is powered and interrupted in a cycle to gather all information collected by down-stream power sink units.

Returning to FIG. 2, there is shown in assembly 200 components for a power sink unit that are provided as a set by a manufacturer. For example, an assembly 200 might include a bottom cover 101 with a cable inlet portion 103 and a cable outlet portion 107. The cable 31 is placed on the bottom cover 101, preferably with a silicon gasket that provides isolation and seals inlet and outlet of the circuit board housing made by top cover 130 and bottom cover 101. The circuit board 120 is placed over the area 105 shown on bottom cover area 101, which preferably has a circuit board seating area which mechanically aligns and holds the circuit board 120. Circuit board 120 is electrically connected to cable 31 power bus, e.g. by a crimp connection for each of the input power and ground lines with a connector fastened respectively to power and ground pads on the lower side of circuit board 120. In an embodiment, circuit board 120 is seated to bottom cover 101 by the crimping connectors that fasten the power and ground pads of circuit board 120 to the power and ground lines of cable 31, and also by the silicon gasket that affixes cable 31 to the opening formed by inlet portions 103 and 141 and to outlet portions 107 and 139. In an embodiment, circuit board 120 is affixed to bottom cover 103 by screws or by a silicon gasket has receptacles for the corners of circuit board 120, so that the corner receptacles extend around cable 31 to hold circuit board 120. Top cover 130 is then mechanically fastened to bottom cover 101, e.g. by clam-shell mechanical fasteners or screws, so that area 137 is aligned with circuit board area 127. The probe 64 then is configured proximate to one or more apertures such as aperture 171 and aperture 172, so that probe 64 receives discharge when assembled through aperture 171 and/or through aperture 172 and the assembly 200 discharges any electrical discharge through the ground of cable 31. In an embodiment, an assembly 200 is replaceable, and does not require soldering for any component in the assembly 200 upon initial installation at a grain bin site, or upon replacement of a component in an assembly 200. In an embodiment, the size of circuit board 120 is about a half inch on each side.

In an embodiment, the voltage at node 41 VCC is an alternating current (ac) power signal. In such an embodiment, parts disclosed are typically rated at higher power levels, e.g. to encompass standard 60 Hz, 120 VAC.

In an embodiment, an isolating circuit 71 can include a series connected resettable fuse in either the ground connection between input ground 42 and local ground 92 or alternatively between input voltage VCC at node 41 and circuit board internal voltage at 91.

In an embodiment, the input power voltage is not a low voltage.

In an embodiment, power sink 74 is an actuator which performs a local function such as opening or closing a valve, switching a motor on or off, turning on or off a piezo-electric sensor, etc.

In an embodiment, communication device 7 is a demodulator, and communication device 57 is a modulator. In an embodiment, communication device 7 is a modulator and communication device 57 is a demodulator.

In an embodiment, isolating circuit 71 has a single resistor R1 on the high side of 150 ohms rated at a half watt, and resistor R2 is then effectively replaced by a trace.

In an embodiment, a single inductor 77 isolates node 41 from node 91, and a single inductor 87 isolates input ground 42 from circuit board ground 92.

In an embodiment, a power sink unit 74 is capable of sensing one or more of temperature, humidity, carbon dioxide, light (via a visible light communication (VLC), hydrogen level, methane level, vapor level, gas level, etc. and stores the sensed information in local storage such as Random Access Memory (RAM), or an electronically erasable memory internal to or coupled to a processor 55.

In an embodiment, the capacitor 93 has low impedance for charging, but discharges through voltage regulator 90, supplying high impedance load so that the capacitor charges in 400 microseconds, but sustains the voltage for more than a millisecond.

In an embodiment, at least one of modems 7 and 57 use current for transmission of symbols. In an embodiment, at least one of modems 7 and 57 modulate voltage. In an embodiment, one of modems 7 and 57 use an M-ary modulation technique, where M is 2 or more. In an embodiment, modems 7 and 57 use a binary modulation technique. In embodiment an M-ary symbol is encoded by one or more of phase encoding, amplitude encoding, frequency encoding, voltage encoding, current encoding and mark space encoding.

In an embodiment, a power sink chain is terminated with an isolating terminal that maintains the separation of cable power and cable ground, so that all housings for circuit board 120 enclosures are uniform, with top cover 130 and bottom cover 101 so that each have both a cable inlet and a cable outlet.

In an embodiment, a communications cycle of a power source 24 with a power sink 74 includes a receive cycle from power sink 74. In an embodiment, a communications cycle of a power source 24 with a power sink 74 includes a transmit cycle to power sink 74. In an embodiment, a single power cycle permits both transmit and receive for a power sink unit 74. In an embodiment, a power outage allows communication of a message that comprises a data bit, a data symbol, parity bits, framing bits, and a source and/or destination address.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

For purposes of this disclosure, the word “including” or “having,” or derivatives thereof, has the same broad meaning as the word “comprising,” and the word “accessing,” or derivatives thereof, comprises “receiving,” “referencing,” or “retrieving.” Further, the word “communicating,” or derivatives thereof, has the same broad meaning as the word “receiving,” or “transmitting” facilitated by software or hardware-based buses, receivers, or transmitters using communication media.

From the foregoing, it will be seen that this technology is one well adapted to attain all the ends and objects described above, including other advantages which are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated the accompanying drawings is to be interpreted as illustrative and not in a limiting sense.

What is claimed is:

1. A circuit comprising:
a probe circuit connected to an input ground line of an input power bus, the probe circuit comprising a probe located proximate to an aperture in a circuit cover;
an isolation circuit connected to an input power line, an input ground line, a circuit board power line, and a circuit board ground line, wherein the isolation circuit comprises a power resistor serving as a component of a low-impedance power loop, the power resistor connected between an input power node and an output power node of the isolation circuit, and wherein the isolation circuit isolates input power and input ground from circuit board power and from circuit board ground; and
a voltage limiting circuit connected to the isolation circuit wherein the limiting circuit limits for the powered circuit the circuit board voltage with respect to the circuit board ground.

2. The circuit of claim 1 wherein the probe circuit comprises a resistor.

3. The circuit of claim 1 wherein the isolation circuit comprises a ground resistor connected between the input ground and the output ground of the isolation circuit.

4. The circuit of claim 3, wherein the power resistor and the ground resistor each have a nominal resistance value high enough to prevent partial semiconductor conductivity and a low power rating.

5. The circuit of claim 1 wherein the input power bus is a direct current power bus.

6. The circuit of claim 5 wherein the powered circuit comprises a capacitor to sustain the voltage to the powered circuit in the event that input direct current power is interrupted.

7. The circuit of claim 5 wherein the input direct current power is suspended for a first time period for the purpose of communication using the wires of the power bus.

8. The circuit of claim 7 wherein the communication is bi-directional.

9. The circuit of claim 7 wherein the power bus is alternately powered in sequence with at least one additional power bus.

10. The circuit of claim 5 wherein the powered circuit is a sensor circuit.

11. The circuit of claim 10 wherein the sensor circuit is one of a plurality of sensor circuits powered by the power bus.

12. The circuit of claim 2, wherein the isolation circuit comprises a power resistor connected between the input power node and the output power node of the isolation circuit, and a ground resistor connected between the input ground and the output ground of the isolation circuit.

13. The improvement of claim 12 wherein the power resistor is nominally of equal value to the ground resistor.

14. A method of providing an electrostatic discharge diversion mechanism comprising:
providing a circuit board housing with an aperture on a cover of the circuit board housing; and
providing a circuit board configured to be mechanically aligned with the circuit board housing so that a probe of the circuit board is proximate to the aperture on the cover, wherein the circuit board comprises:
a probe circuit that comprises the probe and is connected to an input ground of an input power bus,
an isolation circuit connected to the input power bus which provides circuit board power and circuit board ground, wherein the isolation circuit comprises a power resistor serving as a component of a low-impedance power loop, and
a voltage limiting circuit that limits circuit board voltage for a powered circuit relative to circuit board ground.

15. The method of claim 14, wherein the powered circuit comprises a sensor circuit.

16. The method of claim 15, wherein the power bus is used for bidirectional communication between a processor in the powered circuit and a processor in the circuit that provides power to the powered circuit.

17. The method of claim 16, wherein the communication channel symbols are binary.

18. The method of claim 17, wherein the power bus is a dc power bus.

19. The method of claim 18, wherein the dc power bus is an extra-low voltage power bus.

20. An article of manufacture for sensing the condition of grain in a grain bin comprising:
a circuit board housing with an aperture on a cover of the circuit board housing;
and
a circuit board for providing sensor data over an input dc power bus, the circuit board configured to be mechanically coupled to the circuit board housing so that a probe of the circuit board is proximate to the aperture on the cover, the circuit board comprising:
a probe circuit that comprises the probe and is connected to an input ground of an input dc power bus,
an isolation circuit connected to the input dc power bus which provides circuit board power and circuit board ground, wherein the isolation circuit comprises a first resistor connected between the input power node and the output power node of the isolation circuit, the first resistor serving as a component of a low-impedance power loop, and a second resistor connected between the input ground and the output ground of the isolation circuit, and
a voltage limiting circuit that limits circuit board voltage for a powered circuit relative to circuit board ground.
